(19) United States
(12) Patent Application Publication
(10) Pub. No.: US 2015/0109429 A1
(43) Pub. Date: Apr. 23, 2015

(54) DRIVER CONDITION DETECTING DEVICE AND DRIVER CONDITION INFORMING DEVICE

(71) Applicant: Yazaki Corporation, Tokyo (JP)

(72) Inventors: Keisuke INOUE, Susono-shi (JP); Hiroshi ONO, Susono-shi (JP)

(73) Assignee: YAZAKI CORPORATION, Tokyo (JP)

(21) Appl. No.: 14/583,972

(22) Filed: Dec. 29, 2014

Related U.S. Application Data
(63) Continuation of application No. PCT/JP2013/004158, filed on Jul. 4, 2013.

(30) Foreign Application Priority Data
Jul. 6, 2012 (JP) 2012-152363

(51) Int. Cl. G06K 9/00

(52) U.S. Cl. CPC G06K 9/00845; G06K 9/00597
USPC 348/78

(57) ABSTRACT

Disclosed is a driver condition detecting device and a driver condition informing device detecting inattentive or incursive driving by movements of a head and eyeball of a driver during driving. The CPU, when the head and the eyeball of the driver are determined as not facing forward, and neither the vestibule oculogyral reflex movement nor the semicircular carnal cervix reflex movement is detected, determines and informs the inattentive driving. The CPU, even though the head and the eyeball of the driver are determined as facing forward, detects an angle-of-convergence, and determines and informs the inattentive driving when the angle-of-convergence lies above a threshold.

### TECHNICAL FIELD

This invention relates to driver condition detecting devices and driver condition informing devices, particularly, to driver condition detecting devices for detecting inattentive driving or discursive driving of the driver, and driver condition informing devices for informing inattentive driving or discursive driving.

### BACKGROUND ART

Independently of age demographic, motor vehicle accidents are attributed the most to inattentive driving and discursive driving (refer to Japanese government statistics home page, http://www.e-stat.go.jp/). In such situations, advocated as technologies for detecting conditions of drivers are those for detecting awakefullness, especially sleepiness or doze states (see PTLs 1 to 3). Notwithstanding, there has been posed a drawback that detections of sleepiness or doze states cannot solely in the future reduce the vehicle accidents.

### CITATION LIST

### Patent Literature

[PTL 1]
Japanese Patent Application Laid-Open Publication No. 2010-142410
[PTL 2]
Japanese Patent Application Laid-Open Publication No. 2010-128669
[PTL 3]
Japanese Patent Application Laid-Open Publication No. 2008-167806

### SUMMARY OF INVENTION

### Technical Problem

Therefore, an object of the invention is to provide driver condition detecting devices for detecting inattentive driving or discursive driving by movement of head and movement of eyeball of driver during driving.

### Solution to Problem

According to one aspect of the invention to achieve the above mentioned object, there is provided a driver condition detecting device, comprising: a camera unit photographing a face of a driver; a head detector detecting a movement of a head of the driver from an image photographed by the camera unit; an eyeball detector detecting a movement of an eyeball of the driver from the image photographed by the camera unit; a vestibule oculogyral reflex movement detector detecting a vestibule oculogyral reflex movement based on the movement of the head detected by the head detector and the movement of the eyeball detected by the eyeball detector; a semicircular carnal cervix reflex movement detector detecting a semicircular carnal cervix reflex movement based on the movement of the head detected by the head detector and the movement of the eyeball detected by the eyeball detector;

a front face determining unit determining whether or not the head and the eyeball of the driver face forward based on the movement of the head detected by the head detector and the movement of the eyeball detected by the eyeball detector; and an inattentive driving determining unit determining an inattentive driving, wherein said inattentive driving determining unit actuates the vestibule oculogyral reflex movement detector and the semicircular carnal cervix reflex movement detector upon the front face determining unit determining the head and the eyeball of the driver as not facing forward, and determines as the inattentive driving upon neither the vestibule oculogyral reflex movement nor the semicircular carnal cervix reflex movement being detected.

Preferably, the driver condition detecting device further comprises an angle-of-convergence detector detecting an angle of convergence of the eyeball from the image photographed by the camera unit, wherein the inattentive driving determining unit determines the inattentive driving by the angle of convergence detected by the angle-of-convergence detector lying above a threshold upon the front face determining unit determining the head and the eyeball of the driver as not facing forward.

According to another aspect of the invention, the driver condition detecting device comprises: a camera unit photographing a face of a driver; a head detector detecting a movement of a head of the driver from an image photographed by the camera unit; an eyeball detector detecting a movement of an eyeball of the driver from the image photographed by the camera unit; an angle-of-convergence detector detecting an angle of convergence of the eyeball from the image photographed by the camera unit; a front face determining unit determining whether or not the head and the eyeball of the driver face forward based on the movement of the head detected by the head detector and the movement of the eyeball detected by the eyeball detector; and an inattentive driving determining unit determining an inattentive driving by the angle of convergence detected by the angle-of-convergence detector lying above a threshold upon the front face determining unit determining the head and the eyeball of the driver not facing forward.

Preferably, the driver condition detecting device comprises a discursive condition determining unit determining a discursive condition upon an angular velocity distribution of the eyeball per unit time lying within a predetermined range.

Preferably, the driver condition detecting device further comprises an informing unit informing the driver of the inattentive driving when a determination as the inattentive driving by the inattentive driving determining unit continues over an inattentive driving determining period.

Preferably, the driver condition detecting device further comprises a speed detector detecting a speed of a vehicle, wherein the informing unit sets the inattentive driving determining period short as the detected speed increases.

### Advantageous Effects of Invention

According to the first aspect of the invention, since when the head and the eyeball of the driver is determined as not facing forward by the front face determining unit, the inattentive driving determining unit, if neither the vestibule oculogyral reflex movement nor the semicircular carnal cervix reflex movement is detected, determines inattentive driving. It is thus made possible to determine inattentive driving based on the movement of the head and the eyeball. Furthermore, because the vestibule oculogyral reflex movement and the semicircular carnal cervix reflex movement are detected when line-of-sight faces forward though the head faces rightward, leftward, upward, or downward, it is made possible accurately to determine inattentive driving without determining the above case as inattentive driving.

Furthermore, since the inattentive driving determining unit determines the inattentive driving if the angle of convergence lies above a threshold even though the front face determining unit determines that the head and the eyeball of the driver face forward, it is made possible to determine inattentive driving even though the head and the eyeball of the driver face forward and the angle of convergence becomes large, i.e., the driver looks near side.

Furthermore, besides inattentive driving, discursive condition can be determined.

While the driver during driving looks at every place, the informing unit informs the driver of the inattentive driving according to the invention when determination as the inattentive driving by the inattentive driving determining unit continues over inattentive driving determining period, therefore it is made possible to prevent informing because of only looking at mirror for confirming backward or panels for confirming driving speed, and thus reduce informing the driver of wasted information.

According to the invention, the informing unit sets the inattentive driving determining period shorter as the detected speed increases. It follows from this that when the vehicle travels at low speed, movement variation of the head is relatively large so that the inattentive driving determining period is set long, and that when the vehicle travels at high speed, movement variation of the head is relatively small so that the inattentive driving determining period is set short, allowing to provide the driver with less wasted information.

### BRIEF DESCRIPTION OF DRAWINGS

FIG. 1 is a configuration diagram illustrating a first embodiment of a head-up-display (hereinafter referred to as HUD) where a driver condition detecting unit is installed.

FIG. 2 is an electrical configuration diagram illustrating the HUD shown in FIG. 1.

FIG. 3 is a flow chart illustrating entire flow of process of the HUD shown in FIG. 1 which CPU executes.

FIG. 4 is a flow chart illustrating procedure of the CPU in a driver detection process shown in FIG. 3.

FIG. 5 is a flow chart illustrating procedure of the CPU in a virtual image display position control process shown in FIG. 4.

FIG. 6 is a chart illustrating relationship between an eye point and virtual image display position for explaining calculation of the eye point.

FIG. 7 is a chart illustrating relationship between visible range and display range of the virtual image displayed by the HUD shown in FIG. 1.

FIG. 8 is a time chart for control value of eye point calculation value and control value of aspheric mirror.

FIG. 9A is a chart illustrating an example of display of the virtual image displayed by the HUD shown in FIG. 1.

FIG. 9B is a chart illustrating an example of display of the virtual image displayed by the HUD shown in FIG. 1.

FIG. 10 is a chart explaining display position of the virtual image.

FIG. 11 is a flow chart illustrating procedure of the CPU in a driver condition determination process shown in FIG. 4.

FIG. 12 is a flow chart illustrating procedure of the CPU in a driver condition analysis process shown in FIG. 11.

FIG. 13 is a flow chart for explaining calculation procedure for angular velocity of head and eyeball.

FIG. 14 is a time chart of angular velocity in a yaw direction of the head, right eye, and left eye when vestibule oculogyral reflex movement occurs.

FIG. 15 is a time chart of angular velocity in a pitch direction of the head, right eye, and left eye when semicircular carnal cervix reflex movement occurs.

FIG. 16 is a time chart of angular velocity in a yaw direction of the head, right eye, and left eye when angle of convergence diffusion movement occurs.

FIG. 17 is a chart for explaining the angle of convergence.

FIG. 18 is a chart for explaining movement of line-of-sight of the driver.

FIG. 19 is a time chart of angular velocity in a yaw direction of the head, right eye, and left eye for explaining informing of inattentive driving in the second embodiment.

FIG. 20 is a chart for explaining an area set for sight range.

FIG. 21 is a chart illustrating a display example of virtual image which the HUD shown in FIG. 1.

FIG. 22A is a chart illustrating distribution of head and eyeball in a normal condition.

FIG. 22B is a chart illustrating distribution of head and eyeball in an incursive condition.

FIG. 23 is a flow chart illustrating procedure of the CPU in driver condition determination process in the eighth embodiment.

### DESCRIPTION OF EMBODIMENTS

### A First Embodiment

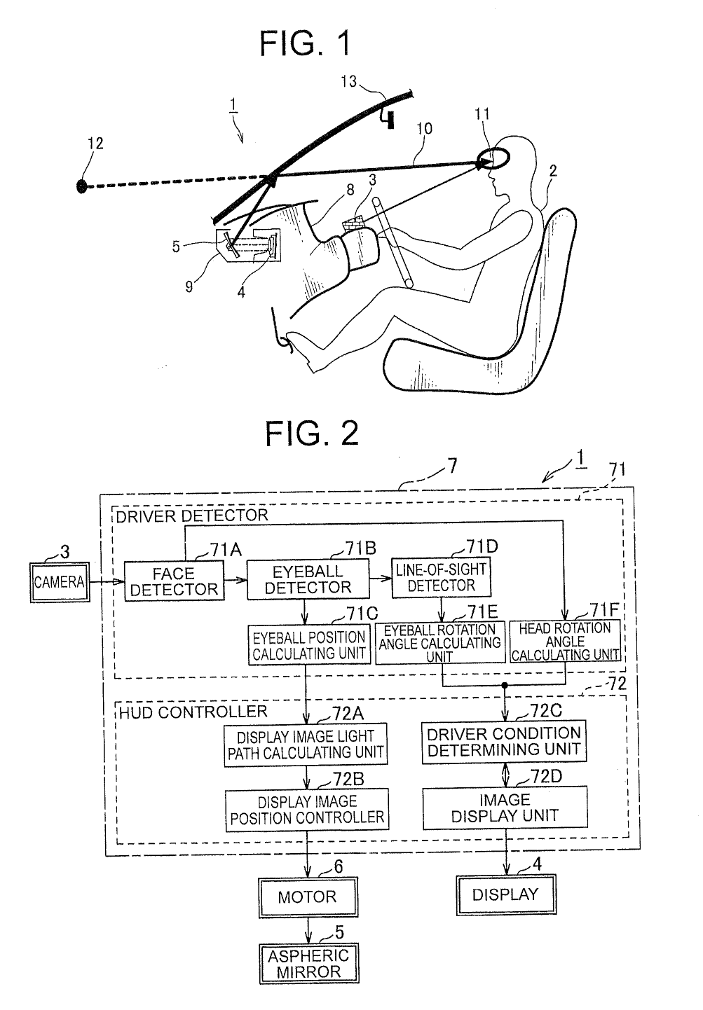

Hereinafter, a head up display (hereafter referred to as HUD) in which a driver condition detecting device of the present invention is installed, is described with reference to FIGS. 1 and 2. As shown in FIGS. 1 and 2 the HUD 1 is provided with a camera 3 as photographing means for photographing a face of the driver 2, a display 4 as emitting means for emitting display light, an aspheric mirror 5 as reflector for reflecting the display light, a motor 6 for adjusting inclination of the aspheric mirror 5, and a CPU 7 for controlling entire the HUD 1.

The camera 3 is, as shown in FIG. 1, mounted on an instrument panel 8 in a vehicle so as to photograph the face of the driver 2, and outputs an image on which the face of the driver 2 is photographed to the CPU 7.

Such the display 4 and the aspheric mirror 5, while accommodated in a HUD housing 9, are accommodated in the instrument panel 8. The aspheric mirror 5 is held such that the inclination is arranged adjustable so that the inclination is adjusted by the motor 6. The display 4 is configured of, for example, a known liquid crystal display device, emitting display light toward the aspheric mirror 5. The aspheric mirror 5 reflects the display light emitted from the display 4 toward a window shield 13 in the vehicle.

The display light reflected on the aspheric mirror 5 travels along a display light pass 10, reflecting on the wind shield 13, reaching to an eye point of the driver 4. This allows the driver 2 to look at the virtual image 12, outside the window shield 13, corresponding to the display image displayed on the display 4.

The CPU 7 is provided with a driver detector 71 detecting a position of eyeball of the driver 2, a rotation angle of the eyeball (movement of the eyeball), and a rotation angle of the head (movement of the head) by image-processing an image photographed by the camera 3, and an HUD controller 72 for controlling the display 4 or the aspheric mirror 5 in accordance with a result of detection from the driver 71.

The driver detector 71 is provided with a face detector 71A for deriving a face area from the image photographed by the camera 3 using known face detecting technology, an eyeball detector 71B for deriving an eyeball area from the face area derived by the face detector 71A using known eyeball detecting technology, an eyeball position calculating unit 71C for calculating an eyeball position (eye point 11) based on the eyeball area derived by the eyeball detector 71B, a line-of-sight detector 71D for detecting a line-of-sight by deriving an iris area from the eyeball area derived by the eyeball detector 71B, an eyeball rotation angle calculating unit 71E as an eyeball detector for calculating a rotation angel of the eyeball based on the iris area derived by the line-of-sight detector 71D, and a head rotation angle calculating unit 71F as head detector for calculating a rotation angle of the head from the face area derived by the face detector 71A.

The HUD controller 72 is provided with a display light path calculating unit 72A for calculating display light path from the eyeball position calculated by the eyeball position calculating unit 71C, a display image position controller 72B for inclining the aspheric mirror 5 so as to reflect on the display light path 10 calculated by the display light path calculating unit 72A by controlling the motor 6, a driver condition determining unit 72C for determining the condition of the driver 2 from the eyeball rotation angle and the head rotation angle, and an image display unit 72D for controlling the display 4.

Then, an operation of the HUD which is configured as mentioned above is generally described. At first, the CPU 7 serves as the driver detector 71, performing driver detection process in accordance with an ignition button being switched-on. The driver detection process is composed of image-processing the image photographed by the camera 3, repeating a face detection of the driver 2, an eyeball detection, a line-of-sight detection, a calculation of the head rotation angle, a calculation of the eye point, a calculation of the eyeball rotation angle and the like, and storing the data into memory.

The CPU also serves as display image position controller 72B, performing virtual image display position controlling process for controlling the aspheric mirror 5 so as to look the virtual image 12 at the eye point 11 of the driver 2 calculated by the driver detection process. Furthermore, the CPU 7 serves as the driver condition detector 72C, performing the driver condition detection process for determining the inattentive driving based on the head rotation angle and the eyeball rotation angle calculated by the driver detection process.

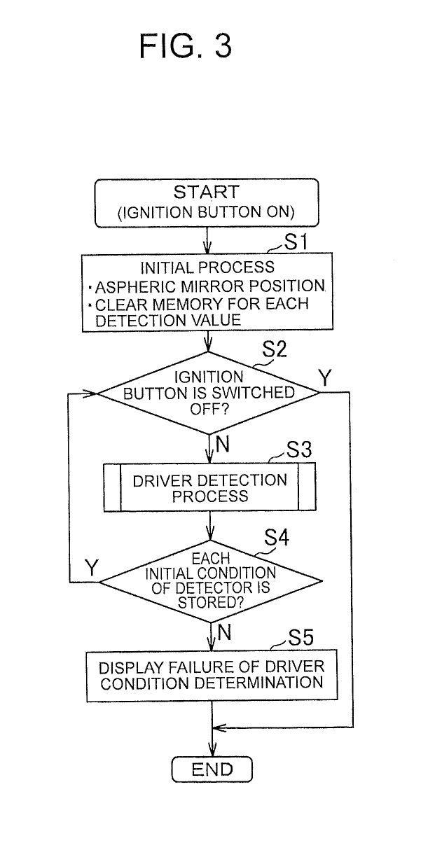

Then, the operation of the HUD 1 is described in detail which is mentioned in the above general description. Firstly, with reference to FIG. 3, a flow is entirely described. The driver 2 switches on the ignition button, and then the CPU 7 executes initial process (step S1). The initial process is such a step as to initialize a position of the aspheric mirror 5 or each detection value. Then, the CPU 7, if the ignition button is not switched off (N in step 2), executes the driver detection process as mentioned above (step S3). The driver detection process is repeatedly performed until the driver 2 switches off the ignition button. When the detection result by the face detection, the eyeball detection, or the line-of-sight detection cannot be stored after predetermined period passes, the CPU 7, determining failure to store default condition by the face detection, the eyeball detection, or the line-of-sight detection (N in step S4), indicates to the driver 2 failure of the driver condition determination, or informs to the driver 2 the failure by warning, and then ends process.

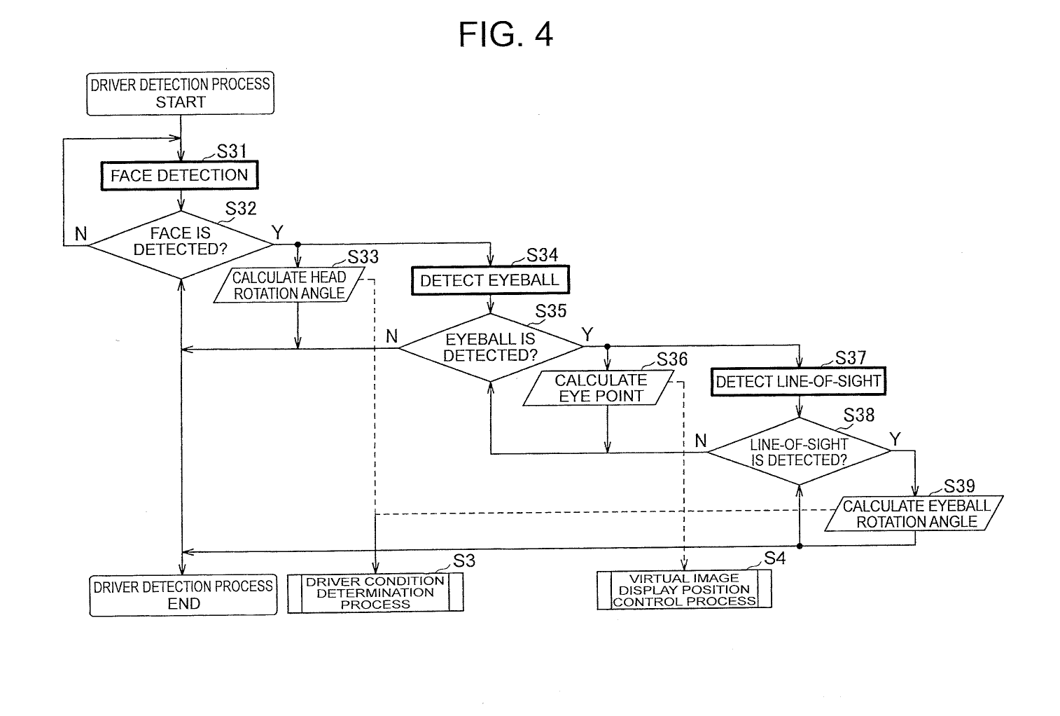

Then, the step S3 of driver detection process is described in detail with reference to the FIG. 4. The CPU 7, when the image of the driver 2 photographed by the camera 3 is inputted, serves as the face detector 71A, starting face detection process for deriving the face area of the driver 2 from the image photographed by the camera 3 (step S31). The camera 3 is integrally composed of an infrared emission LED and an infrared imaging detector, emitting infrared light to the driver 2 so as to image the face of the driver 2 adequately even at night. The CPU 7 continues the face detection until detecting the face, and when detecting the face (Y in step S32), serves as the head rotation angle calculating unit 71F, calculating the head rotation angle from the face area derived (step S33), returning to step S32 after storing it into the memory, and repeating the face detection and the head angle calculation.

The CPU 7, after detecting the face (Y in step S32), also serves as the eyeball detecting unit 71B in parallel with calculating of the head rotation angle, performing the eyeball detection process for deriving the eyeball area from the image photographed by the camera 3 (step S34). The CPU 7, if not detecting the eyeball (N in step S35), again returns to step S32, and again performs face detection. The CPU 7, if detecting the face, repeats the eyeball detection, and when detecting the eyeball (Y in step S 35), calculates the eye point 11 based on the eye area derived (step S36), returning to step S35 after storing it into the memory, then repeating the eyeball detection and calculation of the eye point so as to update the memory. Note that the CPU 7 performs, in parallel with the driver detection process, the virtual image display position control process of controlling the position of the virtual image 12 by controlling the position of the aspheric mirror 5 based on the eye point 11 calculated.

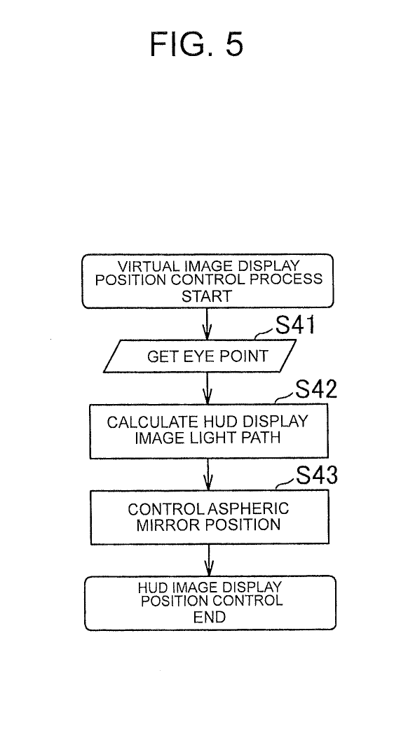

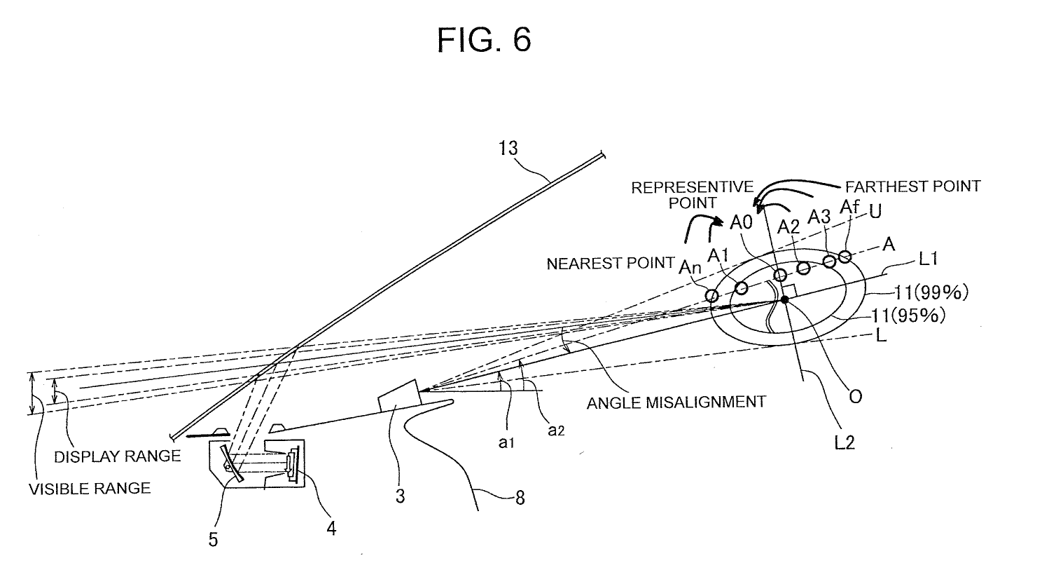

Herein, before the driver detection process is described subsequently, the virtual image display position control process mentioned above is descried with reference to FIGS. 5 and 6. At first, the eye point 11 of the driver 2 destined to observe the image of the HUD 1 is known to generally range within a range of an eclipse which is viewed from side. In FIG. 6, two solid lines on the eclipse represents the range in which the eye point 11 of the driver 2 is distributed, e.g., inner side thereof representing 95 percent, outer side 99 percent. Except for eye point deviating from the range due to discriminating driving pose or body type, each HUD 1 in the compartment is designed to be visible from the eye point 11 of the driver 2 (for example, 99 percent).

However, because of its visible angel being limited to much narrow range, it is impossible for general HUD 1 (in which sufficient sight distance is secured) to be designed to cover the range of presence of the eye point 11 as far as the virtual image 12 is fixed. It is thus generally necessary for the driver 2 to adjust vertical position of the virtual image 12 manually in such a way that the virtual image 12 can be looked at in the eye point 11 of the driver 2.

In this embodiment, to calculate automatically the eye point 11 of the driver 2 by the driver detection process, and to move automatically to optimal position allow the virtual image 12 to be necessarily looked at in any body type or driving pose. Extreme poses inadequate for driving are omitted.

Then, the virtual image position control process is described in detail. In FIG. 6, suppose that the eye of the driver 2 lies in the center of the eye point presence range (hereafter eye point center O). The ideal position of the virtual image 12 in this case lies in the canter of the visible range where structures such as an opening of the instrument panel 8 or the housing 9 of the HUD do not shield. When the eye lies in the eye point center O, the camera 3 successfully detects an image of the eye at a predetermined elevation angle a1.

Herein, the general position of the eye point 11 is described. Positions of those represented by A in FIG. 6, i.e., A0, A1, A2, . . . An, and Af can be observed from the camera 3 at the same elevation angel a2. When observed as light axis of the HUD 1, this group of eye points 11 becomes slightly high at the farthest point Af, slightly low at the nearest point An. As the nearer the center, the higher the provability becomes in which the eye point 11 is present, the position A0 is defined as representative point of the group of eye points 11, which is projected on the normal line L2 of a straight line L1 which the camera 3 and the eye point center O are joined. That is, the CPU 7 controls the position of the virtual image 12 of the group where the elevation angle a from the camera 3 as the eye point 11 of the driver 2 is observed, so that the aspheric mirror 5 is controlled at the position corresponding to the representative point A0, where the eye point 11 on space is defined as representative A0 even if actual eye point 11 is present between An and Af.

A corresponding table of the elevation angle a of the eye from the camera 3 and the representative A0 of the eye point 11 corresponding to the elevation angel a of the eyeball being thus stored into not-shown memory. While calculating the eye point at the step S36, the CPU 7 obtains the elevation angle a of the eyeball, calculates and stores in the memory the representative point A0 as the eye point 11 corresponding to the elevation angel a obtained from the corresponding table.

Then, in the virtual image display position process, as shown in FIG. 5, the CPU 7 obtains the representative A0 calculated in the driver detection process (step S41), calculates a display light path as the eye point 11 being present at the representative A0 (step S42), controls the motor 6 to incline the aspheric mirror 5 such as to reflect on the display light path 10, and ends the process. The virtual image display position control process is executed every calculation of the eye point 11.

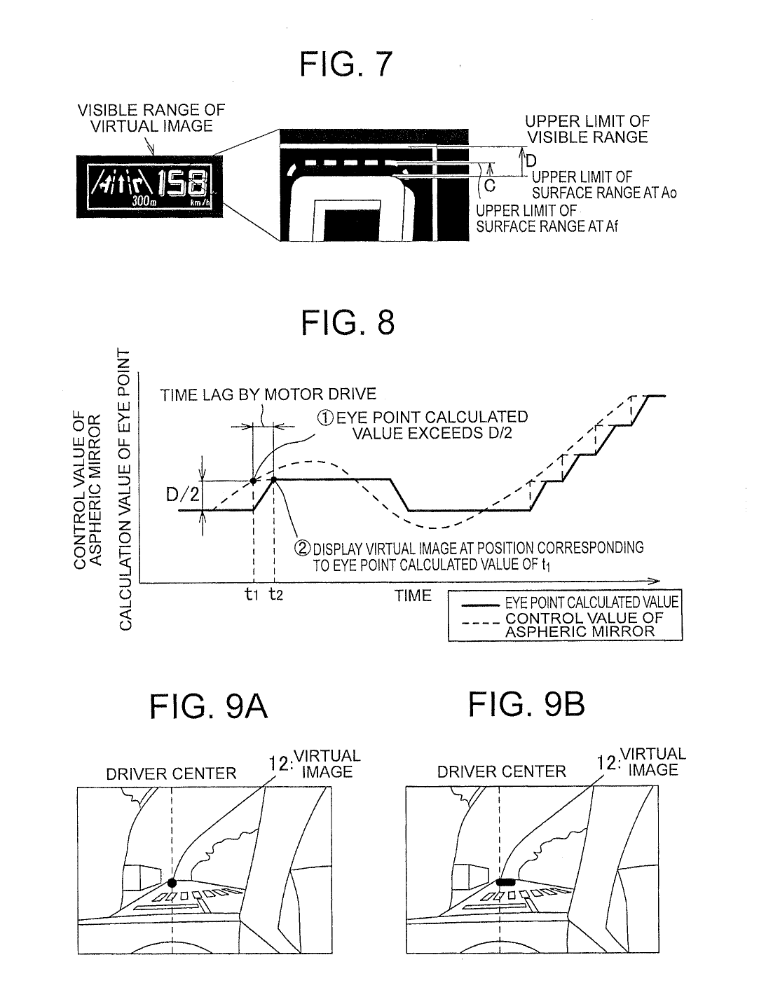

Now, a control of the motor 6 in the above mentioned step S43 is described in detail. As shown in FIG. 7, in the HUD 1 visible range of the virtual image 12 is not typically used fully for display range, i.e., the visible range and the display ranges have some room. The room is substituted for that in absence of image upon temporal movement of eye by such oscillation.

In the FIG. 7, difference between display upper limit and visible range limit is defined as D when the virtual image 12 is controlled at optimal position of representative point A₀. As shown in FIG. 6 when the eye point 11 is present on line of the position A (that is, elevation angel a₂), the CPU 7 controls aspheric mirror 5 on the basis of the representative point A0, virtual image 12 is usually visible from a group of eye point 11 representing elevation a₂ by optical room or dimension of virtual image 12 being designed within a range in which D is arranged larger than C, where C is defined as difference between upper limit of the virtual image 12 at the point of A_{f} where the virtual image is observed the highest. It should be noted that since the above mentioned room is reduced from D to D minus C, to secure D minus C as necessary room for design allows to secure good visibility even at the point of A_{f}.

Then, as shown in FIG. 8, the CPU 7 calculates variation between the eye point 11 calculated when adjusting the aspheric mirror 5 before, and that calculated this time, and when the variation exceeds D/2, controls so as to adjust incline of the aspheric mirror 5 on the basis of the eye point 11 calculated at the time of exceeding. In other words, during the variation of the eye point 11 being below D/2, the aspheric mirror 5 is remained unadjusted.

In fact, designing adequately visible range of the virtual image 12 and the camera 3, or visible room from the farthest two points of a range of presence of the eye point only by two dimensional information allows the position of the virtual image 12 to lie within a usual visible range.

Also, as a method of specifying the eye point 11 using means of deriving distance information for eyeball position as represented by PTL such as Japanese Patent Application Laid-Open 2011-149942, or 2008-09162, the eye point 11 can be specified.

Furthermore, the CPU 7 in the example shown in FIG. 7 indicates navigation information or car speed, but as shown in FIGS. 9A, and 9B, may indicate the virtual image 12 showing recommended position the driver 2 should look at during driving. As the virtual image 12 its dimension may be as large as to avoid hindering the driver 2 to look forward, for example, as shown in FIG. 9A a circular mark may be indicated, or as shown in FIG. 9B a linear mark showing car width may be indicated. These marks may be indicated in the center of the display 4.

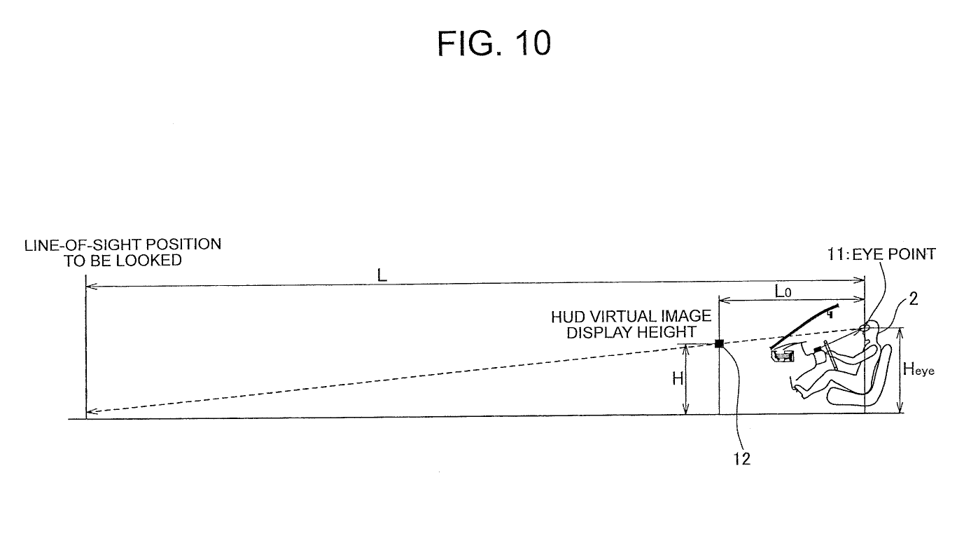

Note that the display position or the size of the HUD 1 is expressed using equations (1), and (2) below (see FIG. 10)

[Math. 1]

S=((L−L₀)/L)H_{eye} (1)

S=(L₀/L)S₀ (2)

where S is display height of the virtual image, S is display size in the display, H_{eye} is a height of the eye point, L₀ is a distance from the virtual image 12 to the eye point 11, L is a distance from the position to the eye point 11, and S₀ is a size at face displaying the virtual image 12.

Next, returning to the driver detection process shown in FIG. 4, operation after detection of the eyeball is described. After detecting the eyeball, The CPU 7 performs line-of-sight detection (step S37) in parallel with calculation for the eye point. If not detecting the eyeball (N in step S38) the CPU 7 returns to step 35. In step S35, when determining failure to detect the eyeball the CPU 7 again performs the line-of-sight detection. When repeating this process, and determining detection of the eyeball (Y in step S38), the CPU 7 calculates eyeball rotation angel at that time (line-of-sight direction), and stores it to the memory (step S39). While being able to detect this line-of-sight detection, the CPU 7 continuously calculates this eyeball rotation angel to update the memory.

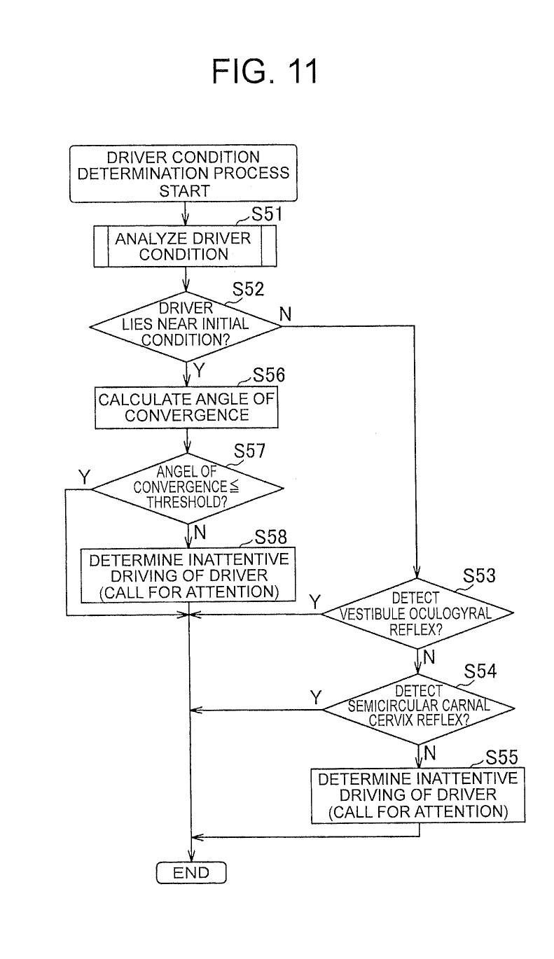

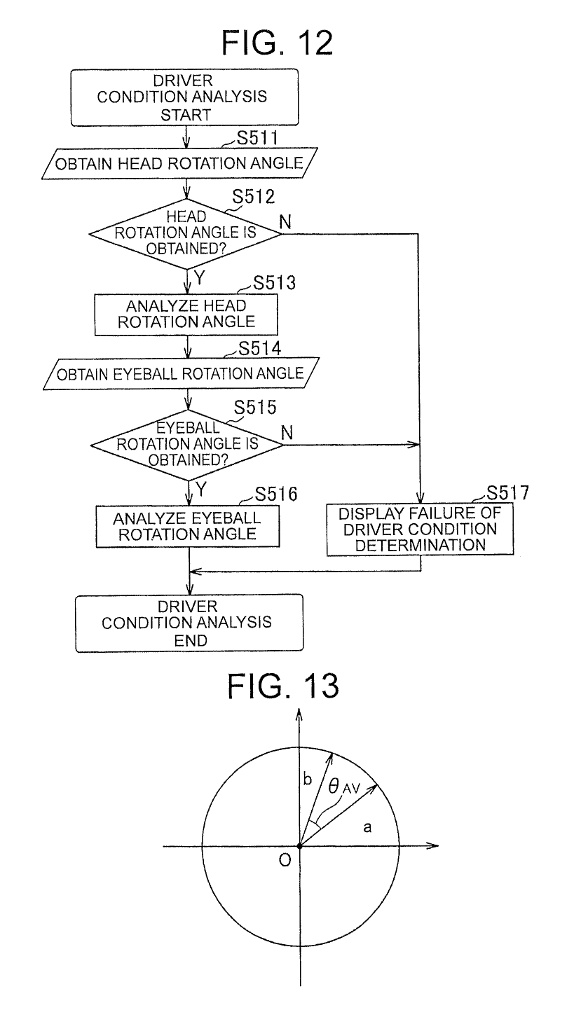

The CPU 7, using the head rotation angle and the eyeball rotation angle thus calculated, performs driver condition determination process. This driver condition determination process is described with reference to FIGS. 11 and 12. The CPU 7, in the driver condition determination process, first performs driver condition analysis (step S51). In this driver condition analysis the CPU 7, as shown FIG. 12, obtains values of the head rotation angle and the eyeball rotation angle (steps S511 and S514), and analyzes the head rotation angle and the eyeball rotation angle obtained (steps S513 and S514). At this time if being able to obtain neither the head rotation angle nor the eyeball rotation angle (N in step S512 or S515), the CPU 7 communicates to the driver 2 failure of the driver condition determination via information display or warning (step S517).

Note that in the analysis for the head rotation angle and the eyeball rotation angle, as shown in FIGS. 13 to 16, angular velocity of the head and the eyeball is each obtained in directions for pitch (that is, rotation around right and left axis), roll (rotation around back and forth axis), and yaw (rotation around back and forth axis).

Herein, a method for calculating angular velocity omega from the head rotation angel and the eyeball rotation angle is described with reference to FIG. 13. As shown in FIG. 13 when the head rotation angle and the eyeball rotation angle moves from vector a calculated last time to vector b newly calculated of the head rotation angle and the eyeball rotation angle, the angular velocity omega at the time is expressed using

[Math. 2]

ω=θ_{AV}/t (3)

where θ_{AV} is angle for movement from the vector a calculated last time to the vector b newly detected, t is time required for movement from the vector a calculated last time to the vector b newly detected.

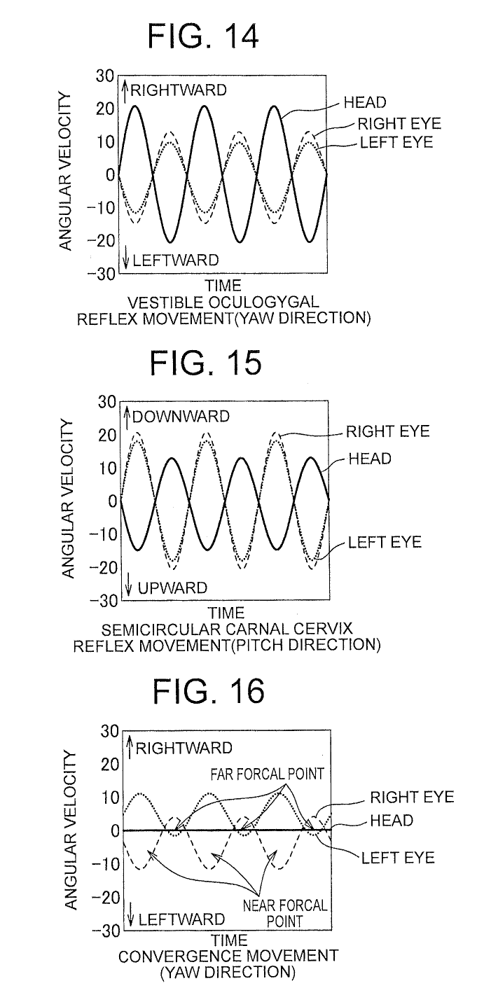

Next, a method for determining inattentive driving of the driver 2 from the head rotation angle and the eyeball rotation angel is described with references to FIGS. 14 to 16 and TABLES 1 to 6.

TABLE 1

| | | | | | |
|---|---|---|---|---|---|
| DRIVER | D11 | D12 | D13 | D14 | D15 |
| CONDITION | | | | | |
| HEAD | FORWARD | FORWARD | FORWARD | FORWARD | FORWARD |
| MOVEMENT | | | | | |
| EYEBALL | FORWARD | RIGHTWARD | RIGHTWARD | LEFTWARD | LEFTWARD |
| MOVEMENT | | | | | |
| OF RIGHT | | | | | |
| EYEBALL | FORWARD | RIGHTWARD | LEFTWARD | RIGHTWARD | LEFTWARD |
| MOVEMENT | | | | | |
| OF LEFT | | | | | |
| IMAGE FIGURE | 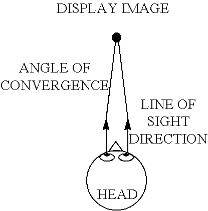 | 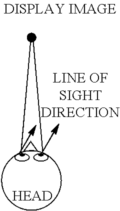 | 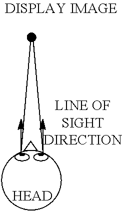 | 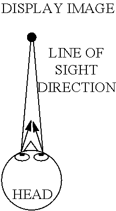 | 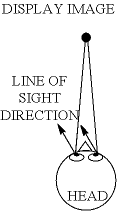 |
| DETECTING | INITIAL CONDITION | | DIVERGENCE | CONVERGENCE | |
| METHOD | (ANGLE OF | | MOVEMENT | MOVEMENT | |
| | CONVERGENCE = | | (ANGLE OF | (ANGLE OF | |
| | THRESHOLD) | | CONVERGENCE < | CONVERGENCE > | |
| | | | THRESHOLD) | THRESHOLD) | |
| DE- | LOOK FORWARD | LOOK | LOOK | LOOK NEAR | LOOK |
| TERMINATION | | RIGHT FRONT | FAR DISPLAY | DISPLAY IMAGE | LEFT FRONT |
| | | (INATTENTIVE | IMAGE | (INATTENTIVE | (INATTENTIVE |
| | | DRIVING) | | DRIVING) | DRIVING) |

TABLE 2

| | | | | | |
|---|---|---|---|---|---|
| DRIVER | D21 | D22 | D23 | D24 | D25 |
| CONDITION | | | | | |
| HEAD | RIGHTWARD | RIGHTWARD | RIGHTWARD | RIGHTWARD | RIGHTWARD |
| MOVEMENT | | | | | |
| EYEBALL | FORWARD | RIGHTWARD | RIGHTWARD | LEFTWARD | LEFTWARD |
| MOVEMENT | | | | | |
| OF RIGHT | | | | | |
| EYEBALL | FORWARD | RIGHTWARD | LEFTWARD | RIGHTWARD | LEFTWARD |
| MOVEMENT | | | | | |
| OF LEFT | | | | | |
| IMAGE FIGURE | 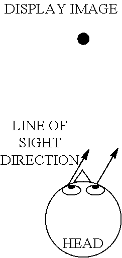 | 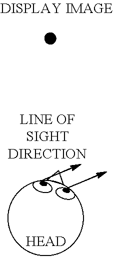 | 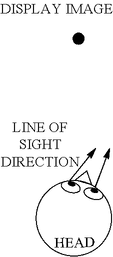 | 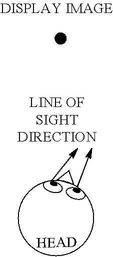 | 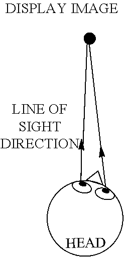 |
| DETECTING | | | | | VESTIBULE |
| METHOD | | | | | OCULOGYRAL |
| | | | | | REFLEX |
| DE- | LOOK | LOOK | LOOK FAR | LOOK NEAR | LOOK |
| TERMINATION | RIGHT FRONT | RIGHTWARD | RIGHT FRONT | RIGHT FRONT | FORWARD |
| | (INATTENTIVE | (INATTENTIVE | (INATTENTIVE | (INATTENTIVE | |
| | DRIVING) | DRIVING) | DRIVING) | DRIVING) | |

TABLE 3

| | | | | | |
|---|---|---|---|---|---|
| DRIVER | D31 | D32 | D33 | D34 | D35 |
| CONDITION | | | | | |
| HEAD | LEFTWARD | LEFTWARD | LEFTWARD | LEFTWARD | LEFTWARD |
| MOVEMENT | | | | | |
| EYEBALL | FORWARD | RIGHTWARD | RIGHTWARD | LEFTWARD | LEFTWARD |
| MOVEMENT | | | | | |
| OF RIGHT | | | | | |
| EYEBALL | FORWARD | RIGHTWARD | LEFTWARD | RIGHTWARD | LEFTWARD |
| MOVEMENT | | | | | |
| OF LEFT | | | | | |
| IMAGE FIGURE | 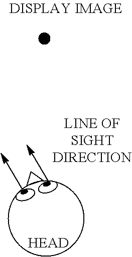 | 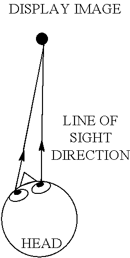 | 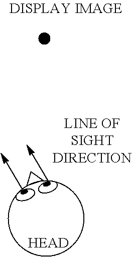 | 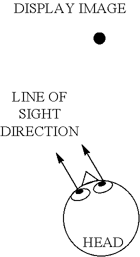 | 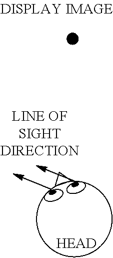 |
| DETECTING | | VESTIBULE | | | |
| METHOD | | OCULOGYRAL | | | |
| | | REFLEX | | | |
| DETERMINATION | LOOK | LOOK FORWARD | LOOK FAR | LOOK NEAR | LOOK |
| | LEFT FRONT | | LEFT FRONT | LEFT FRONT | LEFTWARD |
| | (INATTENTIVE | | (INATTENTIVE | (INATTENTIVE | (INATTENTIVE |
| | DRIVING) | | DRIVING) | DRIVING) | DRIVING) |

TABLE 4

| | | | |
|---|---|---|---|
| DRIVER | D41 | D42 | D43 |
| CONDITION | | | |
| HEAD | FORWARD | FORWARD | FORWARD |
| MOVEMENT | | | |
| EYEBALL | HORIZONTAL | UPWARD | DOWNWARD |
| MOVEMENT | | | |
| IMAGE FIGURE | 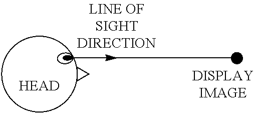 | 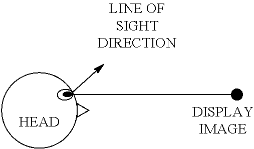 | 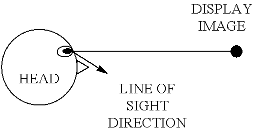 |
| DETECTING | INITIAL | | |
| METHOD | CONDITION | | |
| DETERMINATION | LOOK FORWARD | LOOK UPWARD | LOOK DOWNWARD |
| | | (INATTENTIVE | (INATTENTIVE |
| | | DRIVING) | DRIVING) |

TABLE 5

| | | | |
|---|---|---|---|
| DRIVER | D51 | D52 | D53 |
| CONDITION | | | |
| HEAD | UPWARD | UPWARD | UPWARD |
| MOVEMENT | | | |
| EYEBALL | FORWARD | UPWARD | DOWNWARD |
| MOVEMENT | | | |
| IMAGE FIGURE | 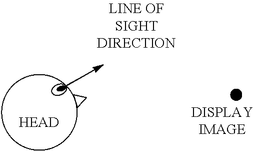 | 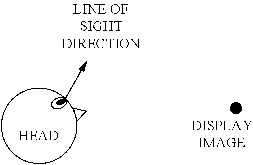 | 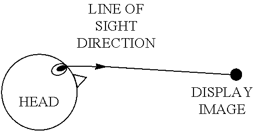 |
| DETECTING | | | SEMICIRCULAR |
| METHOD | | | CARNAL CERVIX |
| | | | REFLEX |
| DETERMINATION | LOOK UPWARD | LOOK NEAR UPWARD | LOOK FORWARD |
| | (INATTENTIVE | (INATTENTIVE | |
| | DRIVING) | DRIVING) | |

TABLE 6

| | | | |
|---|---|---|---|
| DRIVER | D61 | D62 | D63 |
| CONDITION | | | |
| HEAD | DOWNWARD | DOWNWARD | DOWNWARD |
| MOVEMENT | | | |
| EYEBALL | FORWARD | UPWARD | DOWNWARD |
| MOVEMENT | | | |
| IMAGE FIGURE | 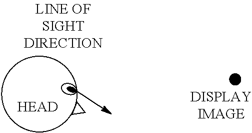 | 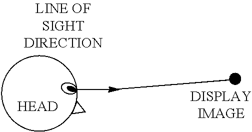 | 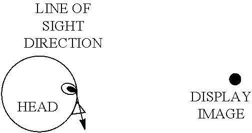 |
| DETECTING | | SEMICIRCULAR | |
| METHOD | | CARNAL CERVIX | |
| | | REFLEX | |
| DETERMINATION | LOOK UPWARD | LOOK FORWARD | LOOK NEAR DOWNWARD |
| | (INATTENTIVE | | (INATTENTIVE |
| | DRIVING) | | DRIVING) |

The CPU 7, using the analysis result in step S51, detects the initial condition, the vestibule oculogyral reflex movement, the semicircular carnal cervix reflex movement, or the angle of convergence of the eyeball of the driver 2, and thus determines the driver condition. After analyzing the driver condition, as shown in FIG. 11, the CPU 7 serves as front determination means, first determining whether the driver 2 lies near the initial condition (step S52). Herein, the initial condition of the driver 2 is such a state that the virtual image 12 can be looked at (driver's state D11 in TABLE 1, or driver's state D41 in TABLE 4). For example, it is thought that when the virtual image 12 is displayed in accordance with the ignition button being switched-on, and the driver 2 is stimulated to follow the virtual image 12, the resultant detected position of the head and the eyeball may be set as the initial condition. At this time, it is supposed that the driver 2 lies in normal driving position. Also determined as what lies near the initial condition is a state that the driver 2 looks at what is far the virtual image 12 (driver's state of D13 in TABLE 1), or a state that the driver 2 looks at what is near the virtual image 12 (driver's state of D14 in TABLE 1).

When determining the driver 2 as not near the initial condition, i.e., the head and the eyeball not facing forward (N in step S52), the CPU 7 serves as the vestibule oculogyral reflex movement detecting means, determining whether or not the vestibule oculogyral reflex movement can be detected from the analysis result of the driver's condition (step S53). The vestibule oculogyral reflex movement, as shown in FIG. 14, is movement which the eyeball makes in a direction cancelling movement of the head when the head moves rightward and leftward, and is thus supposed to be a state that neighborhood of the virtual image 12 is looked at (driver's condition of D25 in TABLE 2, or D32 in TABLE 3).

When angular velocities of the head and the eyeball oppose each other in the yaw direction, the CPU 7 detects the vestibule oculogyral reflex movement. When the vestibule oculogyral reflex movement is detected (Y in step S53), the CPU 7 terminates without informing. On the other hand, if not detecting the vestibule oculogyral reflex movement (N in step S53), the CPU serves as semicircular carnal cervix reflex movement detecting means, determining whether or not semicircular carnal cervix reflex movement can be detected from the analysis result of the driver's condition (step S54).

The semicircular carnal cervix reflex movement, as shown in FIG. 15, is movement which the eyeball makes in a direction cancelling movement of the head when the head moves up and down, and is thus supposed to be a state that neighborhood of the virtual image 12 is looked at (driver's condition of D5 in TABLE 5, or D62 in TABLE 6). When angular velocities of the head and the eyeball oppose each other in the pitch direction, the CPU 7 detects the semicircular carnal cervix reflex movement. When the semicircular carnal cervix reflex movement is detected (Y in step S54), the CPU 7 terminates without informing. On the other hand, if not detecting the semicircular carnal cervix reflex movement (N in step S54), the CPU 7 serves as inattentive driving determination means or informing means, determining the inattentive driving and calling for attention to the driver 2 (displaying information or warning) (step S55).

On the other hand, when determining the driver 2 as near the initial condition, i.e., the head and the eyeball facing forward (Y in step S52), the CPU 7 serves as angle-of-convergence detecting means, calculating angle of convergence (step S56). Herein, before calculating angle of convergence is discussed, convergence and divergence movement is discussed. The convergence and divergence movement is divided into convergence movement (driver's condition of D14 in TABLE 1) in which as shown in FIG. 16, both eyes move inward when looking at near distance, and divergence movement in which both eyes move outward when looking at far distance (driver's condition of D13 in TABLE 1). Provided that the angle of convergence of an angel formed by right and left eyes in the initial condition D11 of the driver 2 is defined as a threshold, it is supposed that when calculated angle of convergence is found larger than the threshold, a side nearer than the virtual image 12 (such instrument panel 8) is looked at. And, when the calculated angle of convergence lies below the threshold, it is suppose that when the initial condition of the driver 2 and divergence movement are detected, neighborhood of, or farther than the virtual image 12 is looked at.

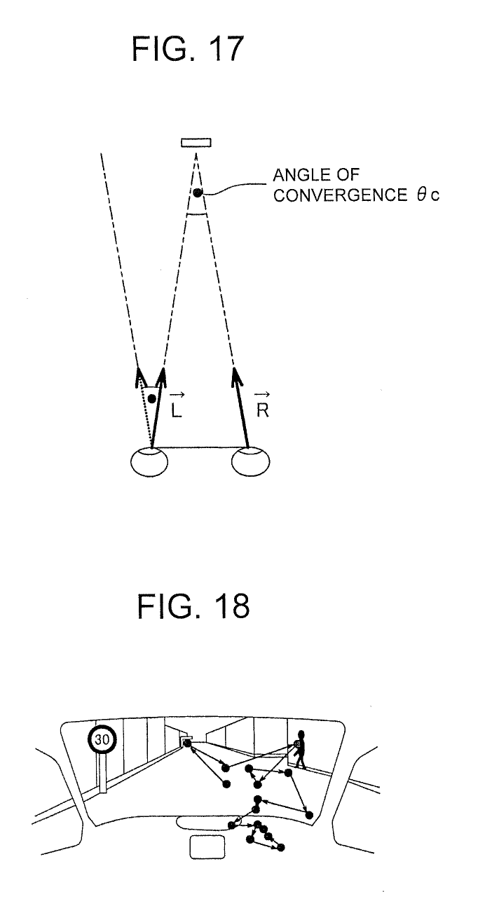

Therefore, if the calculated angle of convergence lies above the threshold (N in step S57), the CPU 7 serves as inattentive driving determining means and informing means, determining inattentive driving and calling for attention to the driver 2 (step S58). On the other hand, if the calculated angle of convergence lies below the threshold (Y in step S 57), the CPU 7 terminates without informing. Note that angle of convergence theta_{c} at this time can be expressed by equation (4) of inner product of line-of-sight vector for right eye and line-of-sight vector for left eye, as shown in FIG. 17.

$$\begin{matrix}[ Math . 3 ] & \\ convergence angle = {cos}^{- 1} \frac{\vec{R} \cdot \vec{L}}{\vert \vec{R} \vert \cdot \vert \vec{L} \vert} \\ \vec{R} \text{:} line \text{-} of \text{-} sight vector for right eye \\ \vec{L} \text{:} line \text{-} of \text{-} sight vector for left eye & ( 4 )\end{matrix}$$

According to the above mentioned embodiment, when the driver 2 does not lie in the initial condition, the head movement and the eyeball movement are determined as not facing forward, and the vestibule oculogyral reflex movement and the semicircular carnal cervix reflex movement are detected by the head movement and the eyeball movement of the driver 2, the driver 2 is determined as looking at forward, but in the case except for the above (the case of neither the vestibule oculogyral reflex movement nor the semicircular carnal cervix reflex movement is detected), the driver 2 is otherwise determined as lying in inattentive driving, and is called for attention. Therefore, inattentive driving is determined on the basis of movement of the head and the eyeball. In addition, since when line-of-sight faces forward even though the head faces rightward, leftward, upward, or downward, the vestibule oculogyral reflex movement and the semicircular carnal cervix reflex movement are detected, this case is not determined as inattentive driving, and thus inattentive driving is determined correctly.

Furthermore, according to the above mentioned embodiment, even though the driver 2 is determined as lying in the initial condition, and the head and the eyeball facing forward, the driver 2 is determined as lying in inattentive driving, looking at neighborhood forward when convergence angle lies above the threshold, and may be called for attention.

### Second Embodiment

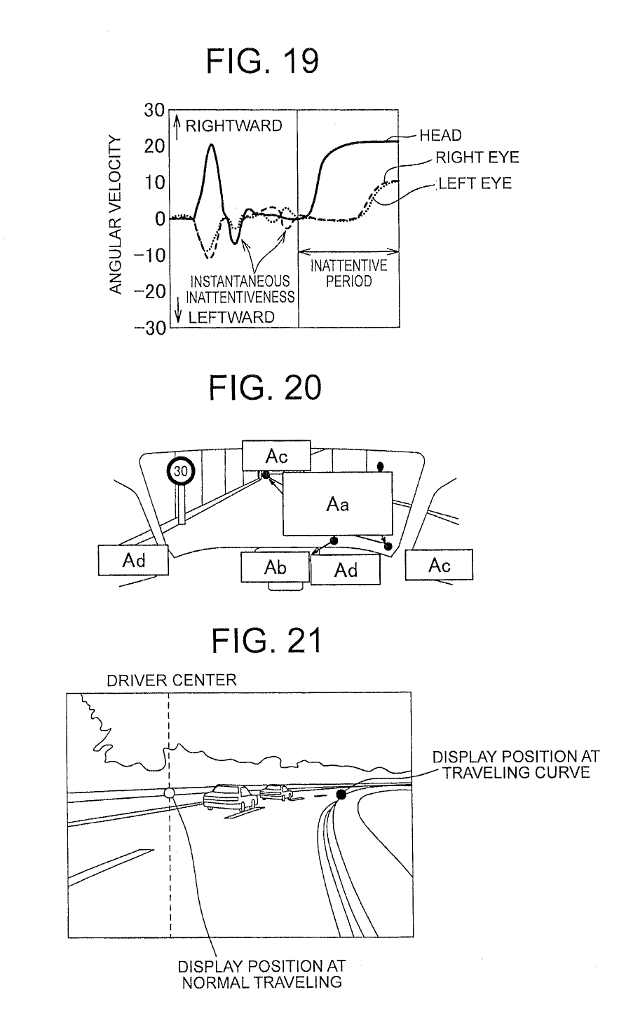

Meanwhile, as shown in FIGS. 18 and 19, during driving the driver 2 drives looking at all around. Therefore, during very short period though lying in inattentive driving, the driver 2 is called for attention. If there increases such erroneous decision, the driver 2 develops distrustfulness, resulting in uselessness. Therefore, it is supposed that when the driver 2 is determined as lying continuously in attentive driving during predetermined inattentive driving period, the driver 2 is called for attention. This makes it possible to reduce wasted calling for attention to the driver 2.

### Third Embodiment

The driver 2, during driving, needs to confirm not only forward but also rearview mirror (room mirror, right and left side mirrors), and instrument panels for confirming car condition or car speed in order to obtain information necessary for driving. In the aforementioned first embodiment, the driver 2 is determined as lying in inattentive driving in such the case, and is called for attention. If there increases such erroneous decision, the driver 2 develops distrustfulness, resulting in uselessness. Therefore, sight range is divided at which the driver 2 should look during driving as shown in FIG. 20, and the above mentioned inattentive driving determining periods are allocated with respect to the divided areas Aa to Ad, and the inattentive driving of the driver 2 is thus determined. Specifically, the areas Aa to Ad, and periods corresponding to the areas Aa to Ad is preliminarily stored in the memory as storing means. When determining inattentive driving, the CPU 7 serves as area detecting means, detecting the areas Aa to Ad at which the driver 2 looks from rotation angle of the head and the eyeball detected in the driver detection process, obtaining periods corresponding to the detected areas Aa to Ad from the memory, setting the obtained periods as the above mentioned inattentive driving determining periods. This thus makes it possible to reduce wasted calling for attention to the driver 2.

It may be though that because variation of the head movement as the inattentive driving determining period while driving fast is relatively large, the inattentive determining period is made long, and that because variation of the head movement while driving low is relatively small, the inattentive determining period is made short. Described in detail, the CPU 7 serves as speed detecting means, detecting car speed from output of running sensor, as the detected speed becomes high, the inattentive driving determining period is arranged short. This makes it possible to reduce wasted calling for attention to the driver 2. Note that though in the above is described period of boarding, low speed, or high speed, but period of middle speed may be set.

### Forth Embodiment

Meanwhile, it is known that while entering into and passing through curved road, the diver 2 intends to look at tangent point (tangent point of straight line passing eye point and inside of the curved) (refer to, M. F. Land and D. N. Lee, “Where we look when we steer”, pp. 742-744, vol. 369, Nature, 30^{th} June, 1994). As far as the car being entering into curve is detected by an image from a mounted camera for photographing traveling direction, an inside edge of the curve is detected from the image from the mounted camera for photographing traveling direction, and as shown in FIG. 21 display position is moved to the tangent point at which the driver 2 should look during driving. This makes possible reduction of driving burden of the driver 2 on being entering into the curve when the driver 2 looks at the display of the tangent point, achieving steadiness of driving control. If the driver 2 fails to look at the tangent point, attention is otherwise called for to the driver 2.

### Fifth Embodiment

In the aforementioned embodiment, as shown in FIGS. 9A, 9B, display is usually displayed at which the driver 2 during driving should looks (proposed position) as large as not to disturb sight forward of the driver 2. The invention, however, is not limited to this embodiment. Since perception for display size in forward sight varies between individuals, which may disturb their driving. Therefore, it is supposed that during traveling display of the position at which the driver 2 during driving should looks is switched off, and which is switched on only when inattentive driving is informed. This makes botheration of display reduced during normal traveling.

### Sixth Embodiment

In the aforementioned first embodiment, each time variation for the eye point 11 exceeds control determination value (D/2 in the first embodiment) with respect to control of the aspheric mirror 5, inclination of the aspheric mirror 5 was newly adjusted where the eye point at that time corresponds to. The invention, however, is not limited to this embodiment. For example, it is thought that since the head movement becomes large during boarding or traveling at low speed, decreasing the above mentioned control determination value makes it possible to follow susceptibly relative to the eye point calculation value (shortening average movement period), and that since the head movement becomes small during traveling at high speed, increasing the above mentioned control determination value makes it possible to follow insensitively relative to the eye point calculation value (lengthening average movement period). Note that in the above period of boarding, low speed, or high speed is described but period of middle speed may be set.

### Seventh Embodiment

In the display image positioning control, it is though that for example, on the basis of the eye point calculation value for the initial condition (driving position) of the driver 2 upon boarding, the position at which the driver 2 should look is determined. This makes calling for attention even when the driving pose collapses.

### Eighth Embodiment

Though in the above mentioned first embodiment, inattentive driving is determined and informed, but the invention is not limited to this embodiment. In order for the driver 2 quickly to find subject for sight in forward line-of-sight during driving, the driver's eye is made moving instinctively and finely. Therefore, the driver 2 during driving concentrates so as to predict any risk from forward line-of-sight and quickly find risky subject, the eyeball movement thus moves quickly and frequently during short stop period such as about 0.1 second to 1 second, and the eyeball fluctuates finely to such an extent as 0.1 angular degree (FIG. 18). When the eyeball movement becomes dull and fewer, and this fine fluctuation becomes fewer, i.e., the stop period of about 0.1 second to 1 second of the eyeball fluctuation becomes decreased, whereas that of longer than 1 second becomes increased, it is supposed that the driver 2 is driving in discursive condition.

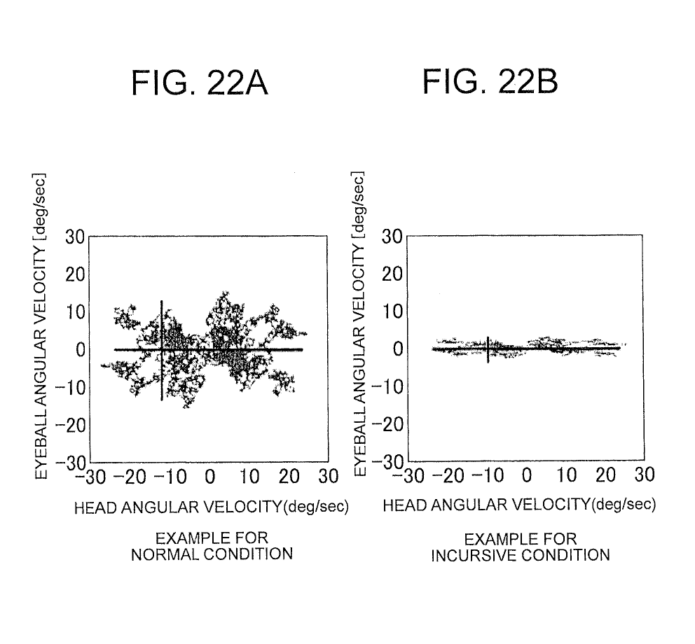

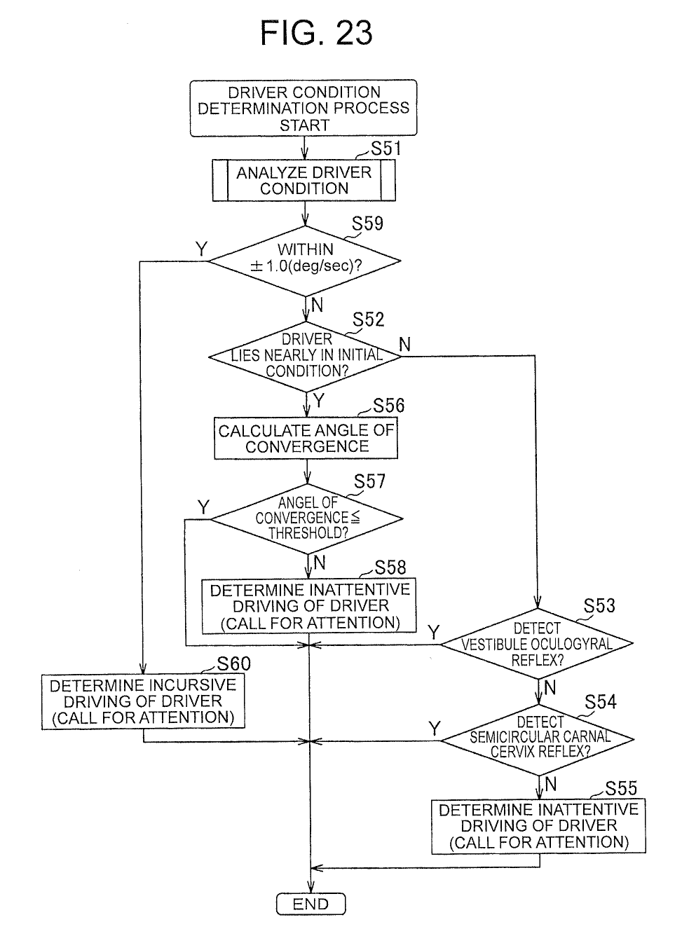

In normal driving, as the driver 2 concentrates to drive, in relationship between the head movement and the eyeball movement, the distribution of the head movement and the eyeball movement ranges widely as shown in FIG. 22A. On the contrary, when the driver 2 lies in discursive condition, the eyeball movement becomes dull and fewer, and in the relationship between the head movement and the eyeball movement as shown in FIG. 22B, the angular velocity of the eyeball movement becomes decreased, centering to nearly +/−1/0 deg/sec within certain time period. A flow of driver condition determination process using this method is shown in FIG. 23. Note that, the same steps in FIG. 23 as described in the above mentioned first embodiment about FIG. 11 are provided with the same reference signs and detailed description thereof is not repeated herein.

As shown in FIG. 23, after analyzing the driver condition (step S51), the CPU 7 serves as discursive condition determining means, when the angular velocity distribution per unit period as shown in FIGS. 22A, 22B lies within +/−1/0 deg/sec (that is, within the predetermined range) (Y in step S59), determining as incursive condition and calling for attention to the driver 2 (step S60). When the angular velocity distribution lies above +/−1/0 deg/sec (N in step S59), the CPU 7 proceeds to step S 52, where detailed subsequent description is the same as the first embodiment and thus is not repeated.

Accordingly, the head movement and the eyeball movement makes possible detecting not only inattentive driving of the driver but incursive condition. Note that while the determination threshold for the incursive condition is set to nearly +/−1.0 deg/sec in the above description, it may be set tight (for example, +/−2.0 deg/sec) because of presence of individual difference.

Note that in the embodiment when the driver is determined as not in condition of driving, method for calling for attention to the driver may be such as visual transmitting means (information presentation), aural transmitting means (warning), or somatosensory transmitting means (vibration of steering, sheet, or sheet belt).

The aforementioned embodiments merely disclose such as, but not limited to, typical embodiment of the present invention. Namely, it is to be understood that various changes and modifications will be apparent to those skilled in the art. Therefore, unless otherwise such changes and modifications depart from the scope of the present invention hereafter defined, they should be construed as being included therein.

### REFERENCE SIGNS LIST

2 driver
3 camera (photographing means)
4 display (emitting means)
5 aspheric mirror (reflection plate)
7 CPU (head detection means, eyeball detection means, vestibule oculogyral reflex movement detection means, semicircular carnal cervix reflex movement detection means, front determination means, inattentive determination means, conversion angle detection means, incursive condition detection means, notice means, velocity detection means)

1. A driver condition detecting device, comprising:
a camera unit photographing a face of a driver;
a head detector detecting a movement of a head of the driver from an image photographed by the camera unit;
an eyeball detector detecting a movement of an eyeball of the driver from the image photographed by the camera unit;
a vestibule oculogyral reflex movement detector detecting a vestibule oculogyral reflex movement based on the movement of the head detected by the head detector and the movement of the eyeball detected by the eyeball detector;
a semicircular carnal cervix reflex movement detector detecting a semicircular carnal cervix reflex movement based on the movement of the head detected by the head detector and the movement of the eyeball detected by the eyeball detector;
a front face determining unit determining whether or not the head and the eyeball of the driver face forward based on the movement of the head detected by the head detector and the movement of the eyeball detected by the eyeball detector; and
an inattentive driving determining unit determining an inattentive driving,
wherein said inattentive driving determining unit actuates the vestibule oculogyral reflex movement detector and the semicircular carnal cervix reflex movement detector upon the front face determining unit determining the head and the eyeball of the driver as not facing forward, and determines as the inattentive driving upon neither the vestibule oculogyral reflex movement nor the semicircular carnal cervix reflex movement being detected.

2. The driver condition detecting device as claimed in claim 1, further comprising an angle-of-convergence detector detecting an angle of convergence of the eyeball from the image photographed by the camera unit,
wherein the inattentive driving determining unit determines the inattentive driving by the angle of convergence detected by the angle-of-convergence detector lying above a threshold upon the front face determining unit determining the head and the eyeball of the driver as not facing forward.

3. A driver condition detecting device, comprising:
a camera unit photographing a face of a driver;
a head detector detecting a movement of a head of the driver from an image photographed by the camera unit;
an eyeball detector detecting a movement of an eyeball of the driver from the image photographed by the camera unit;
an angle-of-convergence detector detecting an angle of convergence of the eyeball from the image photographed by the camera unit;
a front face determining unit determining whether or not the head and the eyeball of the driver face forward based on the movement of the head detected by the head detector and the movement of the eyeball detected by the eyeball detector; and
an inattentive driving determining unit determining an inattentive driving by the angle of convergence detected by the angle-of-convergence detector lying above a threshold upon the front face determining unit determining the head and the eyeball of the driver not facing forward.

4. The driver condition detecting device as claimed in claim 1, further comprising a discursive condition determining unit determining a discursive condition upon an angular velocity distribution of the eyeball per unit time lying within a predetermined range.

5. The driver condition detecting device as claimed in claim 2, further comprising a discursive condition determining unit determining a discursive condition upon an angular velocity distribution of the eyeball per unit time lying within a predetermined range.

6. The driver condition detecting device as claimed in claim 3, further comprising a discursive condition determining unit determining a discursive condition upon an angular velocity distribution of the eyeball per unit time lying within a predetermined range.

7. The driver condition detecting device as claimed in claim 1, further comprising an informing unit informing the driver of the inattentive driving when a determination as the inattentive driving by the inattentive driving determining unit continues over an inattentive driving determining period.

8. The driver condition detecting device as claimed in claim 2, further comprising an informing unit informing the driver of the inattentive driving when a determination as the inattentive driving by the inattentive driving determining unit continues over an inattentive driving determining period.

9. The driver condition detecting device as claimed in claim 3, further comprising an informing unit informing the driver of the inattentive driving when a determination as the inattentive driving by the inattentive driving determining unit continues over an inattentive driving determining period.

10. The driver condition detecting device as claimed in claim 4, further comprising an informing unit informing the driver of the inattentive driving when a determination as the inattentive driving by the inattentive driving determining unit continues over an inattentive driving determining period.

11. The driver condition detecting device as claimed in claim 5, further comprising an informing unit informing the driver of the inattentive driving when a determination as the inattentive driving by the inattentive driving determining unit continues over an inattentive driving determining period.

12. The driver condition detecting device as claimed in claim 6, further comprising an informing unit informing the driver of the inattentive driving when a determination as the inattentive driving by the inattentive driving determining unit continues over an inattentive driving determining period.

13. The driver condition detecting device as claimed in claim 7, further comprising a speed detector detecting a speed of a vehicle,
wherein the informing unit sets the inattentive driving determining period short as the detected speed increases.

14. The driver condition detecting device as claimed in claim 8, further comprising a speed detector detecting a speed of a vehicle,
wherein the informing unit sets the inattentive driving determining period short as the detected speed increases.

15. The driver condition detecting device as claimed in claim 9, further comprising a speed detector detecting a speed of a vehicle,
wherein the informing unit sets the inattentive driving determining period short as the detected speed increases.

16. The driver condition detecting device as claimed in claim 10, further comprising a speed detector detecting a speed of a vehicle,
wherein the informing unit sets the inattentive driving determining period short as the detected speed increases.

17. The driver condition detecting device as claimed in claim 11, further comprising a speed detector detecting a speed of a vehicle,
wherein the informing unit sets the inattentive driving determining period short as the detected speed increases.

18. The driver condition detecting device as claimed in claim 12, further comprising a speed detector detecting a speed of a vehicle,
wherein the informing unit sets the inattentive driving determining period short as the detected speed increases.
